(19) United States
(12) Patent Application Publication
(10) Pub. No.: US 2023/0339142 A1
(43) Pub. Date: Oct. 26, 2023

(54) Power tool for processing a substrate and method for analyzing a composition of the substrate

(71) Applicant: Hilti Aktiengesellschaft, Schaan (LI)

(72) Inventors: Herbert MAYER, Feldkirch (AT); Dragan STEVIC, Feldkirch-Tosters (AT); Christian EBERLE, Friedrichshafen (DE); Martin SCHAEFER, Schwarzach (AT); Gabor VIDA, Chur (CH); Marco BALTER, Rankweil (AT)

(21) Appl. No.: 18/022,624

(22) PCT Filed: Aug. 18, 2021
(86) PCT No.: PCT/EP2021/072912

§ 371 Date: Feb. 22, 2023

(30) Foreign Application Priority Data
Aug. 26, 2020 (EP) 20192790.2

(51) Int. Cl. B28D 7/00

(52) U.S. Cl. CPC B28D 7/005; B28D 1/041

(57) ABSTRACT

A power tool for processing a substrate, the power tool being designed for analyzing a composition of the substrate and including at least one recorder for recording an operating parameter of the power tool. A method for analyzing a composition of a substrate that is being processed by a proposed power tool is also provided. The analysis of the composition of the substrate takes place on the basis of the at least one recorded operating parameter which is recorded with the recording means, the analysis being performed in the power tool itself and during its operation.

The present invention relates to a power tool for processing a substrate.

### BACKGROUND

Power tools with which substrates can be processed are known in the prior art. For example, core drilling devices, with which essentially cylindrical drill cores can be cut out of substrates to be processed, such as masonry, sand-lime brick or concrete, are known. For example, lines, pipes, etc. can then be laid or inserted in the essentially cylindrical boreholes. Also known are concrete saws or saws such as wall saws, with which cuts can be made in substrates.

### SUMMARY OF THE INVENTION

Rebars, reinforcements or water pipes made of iron are often in particular laid in concrete as the substrate. One of the main strengths of core drilling or concrete sawing is that such rebars can be cut through with the drill bits of a core drilling device or with the saw blade of a saw. However, the severing of rebars or water pipes can also pose a risk, especially if it can lead to a weakening of the statics of a structure or to undesirable water damage. A weakening of the load-bearing capacity of a structure, such as a building or a bridge, can pose a serious risk to people living in the surrounding areas, especially in densely populated, urban or earthquake-prone areas.

Above all, inexperienced users of a power tool, such as a core drilling device or a wall or concrete saw, often have difficulties in reliably recognizing a so-called reinforcement hit and distinguishing it from the usual drilling process. Due to the serious consequences that a reinforcement hit or an unintentional severing of a rebar, reinforcement and/or water pipe can have, it would be desirable if a technical possibility could be provided for the reliable recognition of such reinforcement hits.

In addition, experts would welcome it if the billing of such concrete processing operations, such as concrete drilling or concrete sawing, could be made easier. For this it would be helpful if the composition of the substrate to be processed were known.

It is an object of the present invention to overcome the deficiencies and disadvantages of the prior art described above and to provide a power tool for processing a substrate and a method for analyzing a composition of the substrate that is being processed by the power tool, with which reinforcement hits can be reliably recognized and the billing of concrete processing operations can be made easier.

The present disclosure provides a power tool for processing a substrate, the power tool being designed for analyzing a composition of the substrate. The power tool comprises at least one recording means for recording an operating parameter of the power tool and the analysis of the composition of the substrate takes place on the basis of the at least one recorded operating parameter, the analysis being performed in the power tool itself and during its operation. The power tool thus includes an iron detection function with which, in particular, reinforcement hits in the substrate to be processed can be reliably recorded, reported and/or displayed. In addition, the invention allows statements to be made about the composition of the substrate being processed, the underlying analysis of the substrate being processed taking place in particular on the basis of the previously determined operating parameters of the power tool. The operating parameters recorded with the at least one recording means are evaluated in this context in order to draw conclusions about the composition of the substrate. For determining the operating parameters, the power tool comprises at least one recording means; however, in particular two or more recording means are preferred, in order to record different operating parameters of the power tool. The recording means may be for example sensors that can be arranged in or on the power tool or its accessories in order to record data. Tests have shown that the proposed power tool can also be used to determine a proportion of iron or metal in the substrate being processed. This proportion of iron or metal is particularly advantageous if the service of substrate processing with the proposed power tool is to be billed to a customer. It is often agreed that different fees are incurred for straightforward concrete processing or for reinforcement hits or for processing a “mixed substrate”. For the last-mentioned cases in particular, it is helpful to determine a proportion of iron or metal in the substrate being processed, since the results of the substrate analysis carried out in the context of the present invention can be used in a particularly simple and uncomplicated manner to create a bill. In particular, the invention allows up-to-date billing that is accompanied by high transparency and accuracy both for the service provider and for the customer. The billing of concrete work can therefore be considerably simplified by the automation made possible by the invention. In addition, the data are available digitally, so that they can be further processed or sent particularly easily using conventional data processing methods.

In a second aspect, the invention relates to a method for analyzing a composition of a substrate that is being processed by a proposed power tool. The terms, definitions and technical advantages introduced for the power tool preferably apply analogously to the analysis method. The proposed analysis method is characterized by the following method steps:
a) provision of a power tool comprising at least one recording means for an operating parameter of the power tool,
b) operation of the power tool and processing of a substrate,
c) recording of at least one operating parameter of the power tool with the recording means,
d) analysis of the composition of the substrate on the basis of the at least one recorded operating parameter, the analysis being carried out in the power tool itself and during its operation.

The iron detection function or the analysis of the substrate being processed takes place in particular integrated within the power tool. Tool and sensor data are used to examine the states of the processing operation and to find out whether, and if so how much, iron or metal is contained in the substrate being processed. The tool and sensor data used for this purpose are referred to in the sense of the invention as operating parameters, which can be recorded with appropriate recording means on the power tool. The method according to the present invention preferably comprises the detection, information-technology processing, evaluation, classification, compilation, storage and/or transmission of the data, without being restricted thereto. In particular, the proportion of iron or metal in the substrate, preferably comprising concrete, is recorded during operation of the power tool. This is preferably made possible by the fact that the at least one operating parameter is determined and evaluated, i.e. analyzed, during operation of the power tool. The analysis takes place in particular within the power tool itself, for example in control electronics or an evaluation unit provided for this purpose, which may be part of the power tool or the control electronics. The present method can advantageously be carried out essentially automatically.

Tests have shown that a surprisingly high level of accuracy can be achieved with the present invention in detecting the composition of the substrate being processed or in determining the proportion of iron or metal in the substrate. In addition, the results are available particularly quickly due to the determination of the data preferably taking place continuously and during the processing of the substrate and due to the preferably continuous evaluation in the power tool, so that they can be further processed or sent particularly quickly. It is a significant advantage of the invention that with the invention an amount, an area (in the unit sqm) and/or a proportion of iron or metal in a substrate to be processed, such as concrete, can be determined and provided for further processing and/or for display. In addition, benchmarking can be made possible in the sense that the work progress in a project or the processing performance can be determined and documented in a particularly simple and uncomplicated manner. In particular, this allows quick, accurate and transparent billing of concrete processing services provided.

With the iron detection function or with the analysis of the substrate, it is possible in particular to determine an area (in sqm) in which reinforcement hits occur, as well as a proportion of iron, steel or metal in the concrete, as well as an absolute amount of the iron or metal. In other words, the substrate being processed can be analyzed with regard to its composition, the tool and sensor data of the power tool being used for this analysis and the analysis taking place directly in the power tool itself and during its operation

The power tool may preferably be a core drilling device with a drill bit as the tool or a saw, such as for example a wall or concrete saw, with a saw blade as the tool. The invention can of course also be used in connection with various other power tools. The power tool can be used in various working modes. For example, the power tool can be used for manual or assisted cutting, for drilling, sawing, plunge cutting and longitudinal cutting, without being restricted thereto. It is preferred in the sense of the invention that the corresponding working mode of the power tool is recorded by a suitable sensor system, which represents a recording means in the sense of the invention, and is assigned to the other operating parameters, which are preferably determined during operation of the power tool in this working mode. The different working modes that can be carried out with the power tool preferably represent operating parameters in the sense of the invention.

It is preferred in the sense of the invention that the recorded operating parameters or working modes are summarized in a work log. The power tool may preferably be set up to store these work logs for all working modes. For this purpose, the power tool may include for example storage means for storing the operating parameters, the working modes and the results of the analysis. The storage means may be designed for example as a storage module. It is preferred in the sense of the invention that the recorded operating parameters, the working modes, the analysis results and/or the work log can be stored in the storage means, in control electronics of the power tool or on an external device. If the data are stored in an external device, a particularly compact and handy power tool can be provided due to the space and volume savings.

The work log may include the operating parameters, the working modes, a number of reinforcement hits, the worked area or the proportion of the area that has reinforcement hits, cutting or drilling parameters, such as a depth or a diameter of the borehole, a cutting depth or a cutting length, a proportion of iron or metal in the processed material, an energy consumption, a time stamp or a processing duration, i.e. cutting or drilling duration, as well as a cutting or drilling profile, without being restricted thereto. These data may be recorded individually or in combination with one another. A recording means is preferably provided for each data type. It may however also be preferred in the sense of the invention that more than one data type can be determined with one recording means. This preferably means in the sense of the invention that for example two or more operating parameters of the power tool can be recorded with one recording means. This may be for example a first operating parameter, which is derived from the raw data supplied by the recording means, and a second operating parameter, which is derived from this raw data. This derivation may take place in particular by further processing of the data using information technology. For example, an algorithm may be applied to the raw data in order to obtain the second, derived operating parameter. In other words, the data of the work log may be raw data that are recorded directly by the recording means and for example are passed on to the control electronics or the evaluation unit for evaluation. However, they may also be data that have already been further processed using information technology.

It is preferred in the sense of the invention that the analysis for determining the composition of the substrate includes a decision tree model. The cutting or drilling of steel or iron is usually involves more effort than the processing of metal-free concrete. This greater effort manifests itself in particular in higher costs and an increased expenditure of time. However, the concrete itself is not a homogeneous material either, so that a clear distinction between an inhomogeneous concrete and a concrete that includes rebars can be difficult in some cases. In order to improve the precision and the accuracy of the analysis of the composition of the substrate, in particular a large number of operating parameters may be recorded and evaluated with one another in the context of the present invention. In the sense of the invention, it is most particularly preferred that the interrelationships and relationships between the individual operating parameters, as well as their temporal progressions and dependencies, are taken into account when evaluating the data, i.e. when analyzing the composition of the substrate. A decision tree model may be used to further increase the accuracy. The decision tree model may be used in particular to establish relationships between a speed of a motor of the power tool, its torque, its power, its acceleration, as well as derived variables, such as for example signal energy, in order to determine the composition of the substrate being processed. In the sense of the invention, a decision tree model is preferably a method of supervised machine learning in which data are preferably divided continuously in dependence on certain, predetermined parameters. The use of a decision tree model advantageously allows operating parameters to be recorded and evaluated at any point in time during ongoing operation of the power tool in order to classify the substrate and determine its composition. The phrase “at any point in time during ongoing operation of the power tool” preferably means in the sense of the invention that the substrate or its composition can be classified in particular for each new data point of an operating parameter.

It is preferred in the sense of the invention that the analysis for determining the composition of the substrate includes an examination of features of the at least one recorded operating parameter, with in particular statistical properties of the at least one recorded operating parameter being examined. Extended methods of data processing can preferably be used in order to evaluate the statistical properties of the operating parameters. The statistical properties may be for example the arrangement and scattering parameters of the sensor signals during the processing operation. For example, the arrangement of the sensor may be brought into association with a scattering of the data obtained from it, in order in this way to obtain a more accurate evaluation and improved analysis of the operating parameters obtained from this sensor. The extended methods of data processing can include methods of so-called feature generation. In the sense of the invention, the term “feature” should preferably be understood as meaning that it is a measurable property of a data record, a value for this property existing for each observation in the data. The feature generation thus preferably describes the generation of new features by combining and/or transforming existing features.

It is also preferred in the sense of the invention that the analysis for determining the composition of the substrate includes a sliding window approach. Such an approach, also referred to as a moving window approach, is preferably used to take into account a dynamic distribution of the properties of the signals. As a result, statistical distribution parameters such as the mean value, the standard deviation, minimum or maximum values, distortions and/or bulges can be included in the analysis of the operating parameters in order to determine the composition of the substrate being processed. In particular, in this way temporal progressions of the statistical data and properties of the data can be generated or evaluated.

In the context of the sliding window approach, it is preferred in the sense of the invention that the term “window” should be understood such that a window has a defined shape and/or size. A corresponding window can be moved across the data to be analyzed by a window width at a time, in order to statistically summarize the data located in a window section. For example, statistical distribution parameters, such as the number, mean value of all points in the window, minimum values, maximum values, standard deviation and/or coefficient of variance, can be taken into account, without being restricted thereto. Data points, which preferably represent center points of the sliding windows, are again obtained as results. In addition, statistical indicators of the windows may be obtained as attributes of these data points or center points. It is preferred in the sense of the invention that the windows may be moved further by a half-width of the window at a time, for example, if only few data are available. As a result, advantageously more data can be taken into account for the calculation or classification of the substrate. In the sense of the invention, this procedure is preferably referred to as a “sliding window approach with overlapping”.

It is preferred in the sense of the invention that the described recording of the operating data or the data that are summarized in the work logs, as well as the data processing and the analysis of the operating parameters for determining the substrate composition take place in particular in the power tool itself, for example in a evaluation unit provided for this purpose or in the control electronics of the device. As a result, the data stream that has to be transmitted from the power tool, for example to a cloud or in the direction of an external device, can be significantly reduced. In addition, the transmission means can be kept slim and space-saving. An Internet of Things interface, which in the sense of the invention is preferably also referred to as an IoT interface, is preferably used for transmitting the data. In other words, it is preferred in the sense of the invention that the at least one operating parameter and the analysis results or the work logs can be transmitted to a cloud. However, they may also be transmitted to a server or to a PC, a laptop, a tablet PC, a mobile communication device such as a smartphone, a notebook, a smartphone or any other external device for further processing, storage or display. The data may be transmitted in particular using a data connection, the data connections being based for example on Bluetooth (BLE), Global System for Mobile Communications (GSM), Near Field Communication (NFC) and/or WLAN, without being restricted thereto. As a result, the performance and robustness of the iron detection function or the analysis of the composition of the substrate can be significantly improved.

It may be provided in the sense of the invention that the power tool has a memory, the memory being set up to temporarily store data. This may be advantageous for example if a mobile communication link for transmitting and/or passing on data does not currently exist or is temporarily unavailable. By using the memory of the power tool, the temporarily stored data can advantageously be transmitted when the mobile communication link is available again. For example, data can be transmitted by actively establishing contact between the communication partners involved. However, it may also be preferred in the sense of the invention that the data are sent passively or while the power tool is in operation.

It is preferred in the sense of the invention that the analysis method is trained before it is used for the first time in the power tool. This involves using the power tool for processing known substrates and materials for which in particular their composition and the proportion of reinforcing metal or iron as well as their position and distribution in the surrounding concrete are known. The training may then take place using a comparison of the data determined by the power tool with the known composition data. By this training, the power tool and the method can “learn” which are the most important operating parameters for determining the composition of the substrate being processed and how the various operating parameters influence the accuracy of the analysis. It is preferred in the sense of the invention that the accuracy of the analysis can be improved by training the power tool, the training comprising a comparison between composition data that are determined by the methods and composition data of materials with a known composition. In order to further increase the accuracy of the composition data determined with the method or the power tool, a median or central value filter may additionally be used. The median filter is preferably a non-linear digital filter technique that can be used in the context of the present invention for example for removing noise from an image or signal. Such noise suppression may represent a preprocessing step in order to improve the results of later processing, such as for example iron (hit) detection.

It is particularly preferred in the sense of the invention that the method is carried out in an edge-based manner. This preferably means in the sense of the invention that the at least one operating parameter recorded with a recording means is preferably evaluated locally, i.e. decentrally in the power tool, and only a small amount of data has to be transmitted to the cloud or to an external device. In particular, the preferred on-site evaluation of the operating data allows the amount of data that must be stored in the power tool to be kept particularly low. It is preferred in the sense of the invention that the power tool is designed as an edge device. This preferably means in the sense of the invention that the power tool is set up to control or monitor data streams in the border area between different networks.

It is preferred in the sense of the invention that the analysis for determining the composition of the substrate includes a cumulative sum approach. This approach, known as the CUSUM approach, is used in a modified form in the context of the present invention in that the modified CUSUM approach uses changes in the linear feed rate in order to recognize reinforcement hits and thus draw conclusions about the composition of the substrate being processed. Alternatively, the corresponding values of the feed rate can also be used if the movement of the power tool does not take place along a linear axis. In order to further increase the robustness of the analysis method, the limit values may be adapted and updated dynamically.

This adaptation may preferably be based on a feed rate of the processing operation, for example based on the feed rate of a cut if the power tool is a saw or based on the feed rate of a bore if the power tool is a core drilling device. It is preferred in the sense of the invention that the feed rate is obtained from the calculations of the sliding window approach.

It may also be preferred in the sense of the invention to use an idle filter in order to differentiate the final result before the signals are evaluated with the modified CUSUM approach.

With the invention, the reinforcement hits can advantageously be processed almost in real time using information technology, so that with the invention almost real time display of reinforcement and iron hits is made possible. The CUSUM approach can be further modified in dependence on the materials to be processed.

In a most particularly preferred configuration of the invention, the feed rate of the power tool may be adapted or set in dependence on the determined composition of the substrate to be processed. This preferably means in the sense of the invention that operating parameters of the power tool can be adapted or set to this determined composition in dependence on the result of the composition analysis, in order to achieve an optimal cutting or drilling result. For example, the power tool may be moved particularly slowly in the cutting direction if a high proportion of metal or iron is discovered in the concrete to be processed. Similarly, it may be preferred in the sense of the invention that the feed rate of the power tool is increased if essentially iron-free or metal-free concrete is to be processed. In this way, deflection of the tool of the power tool can be reduced and a sudden change in the working pressure can be avoided. In particular, the efficiency of work with the power tool can be increased considerably, since the processing progress is optimally adapted to the substrate to be processed. With the invention, an interaction between the recorded operating parameters and their analysis with regard to the composition of the substrate to be processed on the one hand and the adaptable operating parameters that can be set on the power tool to control the processing operation on the other hand can thus advantageously be achieved.

It is preferred in the sense of the invention that the power tool comprises a display device for displaying the at least one operating parameter, the working modes, the work logs and/or the results of the substrate analysis. In addition, the power tool may include control electronics for evaluating and/or storing the at least one operating parameter and results of the analysis. Furthermore, the power tool may comprise communication means for transmitting the at least one operating parameter and the results of the analysis. It may also be preferred in the sense of the invention that the display device is not part of the power tool, but that it is a separate display device that is set up for example away from the power tool, for example in a monitoring room or in an office.

It is preferred in the context of the present invention that physical operating parameters recorded during the processing operation are evaluated, preferably directly, immediately and on site, in order to determine the composition of the substrate material to be processed, which is being or has been processed. The data and information determined in this way may be temporarily stored in the power tool, with such storage taking place in particular when the data cannot be directly transmitted to the work log with the aid of the communication means. The data may preferably also be displayed via a display device. The display device may be designed for example as a small screen or display. In a particularly preferred configuration of the invention, the data may be sent to a cloud with an IoT interface in order to be processed further there or at another location. The data can be transmitted for example with BLE, GSM, NFC or WLAN, without being restricted thereto.

In the context of the present invention, a method for recognizing a reinforcement hit in a substrate is disclosed as an exemplary embodiment, the substrate being processed with a power tool, for example a core drilling device. The method is characterized by the following method steps:
a) provision of a power tool comprising at least one recording means for at least one operating parameter of the power tool,
b) operation of the power tool and processing of a substrate,
c) recording of at least one operating parameter of the power tool with the recording means,
d) evaluation of the at least one operating parameter, preferably with the aim of detecting a rapid change in the at least one operating parameter,
e) assignment of a rapid change in the at least one operating parameter to a reinforcement hit in the substrate to be processed.

With the invention, preferably a surprisingly reliable possibility for recognizing reinforcement hits can be provided, which makes it easier for the experienced as well as the inexperienced user to recognize reinforcement hits in the substrate to be processed, so that the user can take or initiate further measures. This includes for example making contact with a structural engineer, where the user can decide, following this consultation and depending on the structural engineer's advice, whether the drilling operation is continued or terminated. In this sense, it is preferred in the context of the present invention that the method comprises as a further alternative method step:
the continuation of the processing of the substrate or
the termination of the processing of the substrate.

In the context of this exemplary embodiment of the invention, a power tool which comprises at least one recording means for recording at least one operating parameter of the core drilling device is provided. This recording means is preferably also referred to in the sense of the invention as the “first recording means”. It can be used for example to record information or progressions of the power consumption, the torque, the speed of the motor of the core drilling device or the speed of the drill bit and/or of vibration values. It is preferred in the sense of the invention that the recording means may be or comprises a sensor. However, it may also be preferred that already existing operating parameter data are evaluated in order to recognize a reinforcement hit due to a rapid change. The power tool may be for example a core drilling device. In this configuration of the invention, a control device of the core drilling device may serve for example as a recording means or be referred to as such.

Even if the method in the context of the exemplary embodiment of the invention is described for a core drilling device, a person skilled in the art will recognize that the method steps of the method can easily be transferred to another power tool, such as for example a saw. In this respect, it is also disclosed in the context of the invention that the method can be carried out with a saw. In addition, a power tool, such as a saw, for carrying out the method is disclosed. The described exemplary embodiment of the invention, which relates to a core drilling device, can also be described analogously for a saw by appropriately adapting the statements made.

This recording of the operating parameter takes place during operation of the core drilling device, that is to say preferably when the core drilling device is processing the substrate, that is to say cutting out a drill core from the substrate. In other words, the at least one operating parameter of the core drilling device is preferably recorded during the operation of the core drilling device and during the drilling operation. The at least one operating parameter is then evaluated, specifically preferably with the aim of recognizing a rapid change in the at least one operating parameter. In an exemplary embodiment of the invention, it is possible for example that a first operating parameter recorded with the first recording means is combined with other operating parameters that describe the operation of the core drilling device and are determined for example with a second or further recording means. The combination of these operating parameters may for example be compared with a similar or essentially similar characteristic value over time in order to recognize rapid changes in the first operating parameter quickly and reliably. It is preferred in the sense of the invention that a reinforcement hit is assumed if the characteristic value or the operating parameter changes significantly in only a short time. It can it this way be advantageously determined that the rapid change in the operating parameter is attributable to a reinforcement hit. This step is referred to in the sense of the invention as “assignment of a rapid change in the at least one operating parameter to a reinforcement hit in the substrate to be processed”.

It is preferred in the sense of the invention that the method comprises as a further method step:
stopping a motor of the core drilling device in order to prevent complete severing of an object associated with the reinforcement hit.

This method step preferably means in the sense of the invention that the motor of the core drilling device is automatically and/or immediately stopped in particular when a reinforcement hit is recognized. This is done in particular with the aim of reliably and efficiently preventing complete severing of a rebar, a reinforcement and/or a water pipe. In particular, the preferably immediate stop of the motor of the core drilling device gives the user of the core drilling device time to initiate and/or take remedial measures, such as terminating the drilling at this location and starting new drilling at another location. It may also be preferred in the sense of the invention that the drilling is continued at the originally intended location if consultation with an expert, such as a structural engineer, permits continuation. In this respect, the invention not only provides an effective method for recognizing reinforcement hits. Rather, it also provides a possibility of preventing the possible negative consequences of a reinforcement hit, such as water damage or a weakening of the load-bearing capacity and/or statics of a structure, by continued severing of a rebar, a reinforcement and/or a water pipe made of iron being prevented or only continued after a safety check by an expert. This is achieved in particular by the preferably immediate stopping of the motor of the core drilling device when a reinforcement hit is recognized by the evaluation of operating parameter data.

It is preferred in the sense of the invention that the reliability for the recognition of a reinforcement hit is increased by using more than one recording means. In other words, it is preferred in the sense of the invention that additional recording means or sensors can be used to record further operating parameters of the core drilling device and to take them into account in the evaluation for the recognition of reinforcement hits. Tests have shown that in this way the probability of a reinforcement hit being recognized can be increased to a surprising degree. This applies in particular when, as further operating parameters, different distances and/or the drilling speed are combined with the first operating parameter and compared with a similar characteristic value.

The inventors have recognized that the use of more than one recording means can lead to an increase in the reliability of the recognition of a reinforcement hit. If more than one recording means is used for recording operating parameters, they may preferably be such recording means that are set up to record different operating parameters, that is to say such operating parameters that differ from the first operating parameter recorded with the first recording means. If for example the first recording means is used to record a change in power consumption, a torque, a speed and/or a vibration value, it may be preferred in the sense of the invention that a distance measurement or a drilling speed measurement is performed with the second recording means.

It is preferred in the sense of the invention that a reinforcement hit is displayed on a display device. In other words, it is preferred in the sense of the invention that the core drilling device comprises a display device for displaying a reinforcement hit. The display device may be for example a display, a screen, a monitor or the like.

In one configuration of the invention, the method may include the method step of emitting a warning signal when a reinforcement hit is recognized. This may be for example an acoustic and/or optical signal. In other words, the warning signal may be configured as optical and/or acoustic. For example, a corresponding display may appear on a display of the core drilling device, a light-emitting diode (LED) may flash as a warning signal or a beep may sound as an acoustic warning signal.

In a further exemplary embodiment, a power tool, which may for example be designed as a core drilling device, is disclosed, the core drilling device being set up to carry out the method. This may be achieved for example by the core drilling device comprising at least a first recording means for recording at least one operating parameter of the core drilling device. With the core drilling device disclosed here, in particular a technical solution which ensures that a reinforcement hit is recognized in a substrate processed by the core drilling device can be provided.

In the context of the present invention, a method for recognizing a reinforcement hit in a substrate is also disclosed, the substrate being processed with a drilling system, the drilling system comprising a core drilling device and an automatic feed device. The method disclosed in this exemplary embodiment of the invention is characterized by the following method steps:
a) provision of a drilling system, the core drilling device and/or the automatic feed device comprising a recording means for at least one operating parameter of the core drilling device and/or the automatic feed device,
b) operation of the drilling system and processing of a substrate,
c) recording of at least one operating parameter of the core drilling device and/or the automatic feed device with the recording means,
d) evaluation of the at least one operating parameter, preferably with the aim of detecting a rapid change in the at least one operating parameter,
e) assignment of a rapid change in the at least one operating parameter to a reinforcement hit in the substrate to be processed.

The method disclosed in this exemplary embodiment differs from the core drilling device method in that the substrate is now processed by a drilling system which comprises a core drilling device and an automatic feed device. Another difference is that the at least one recording means can be arranged on the core drilling device and/or the feed device or that operating parameters of the core drilling device and/or the feed device are recorded and evaluated. The evaluation is also carried out with the preferred aim of detecting a rapid change in the at least one operating parameter, a rapid change in the operating parameter being viewed as a reinforcement hit. This step is referred to in the sense of the invention as “assignment of a rapid change in the at least one operating parameter to a reinforcement hit in the substrate to be processed”. It is found that the rapid change in the operating parameter is attributable to a reinforcement hit.

It is preferred in the sense of this drilling system method that a first recording means for recording a first operating parameter may be arranged on the core drilling device and/or on the automatic feed device. A feed device is used to drive heavy power tools, such as core drills, into a substrate. In the context of the present invention, an automatic feed device, which comprises a feed motor, is preferably used. Such automatic feed devices are known for example as autofeed or cut-assist devices. It is therefore preferred in the sense of the invention that the core drilling device is equipped with a recording means or the feed device or both.

Accordingly, in the context of the invention, operating parameters of the core drilling device or the feed device or both components of the drilling system may be recorded and evaluated in order to recognize a reinforcement hit quickly and reliably, the operating parameters preferably being recorded during the operation of the drilling system, i.e. during the drilling operation.

In the evaluation, preferably all of the operating parameters recorded with the recording means are used in order to determine a rapid change in an operating parameter or a combination of operating parameters. In the context of the present invention, such a rapid change in operating parameters is assigned to a reinforcement hit, i.e. if a great rate of change of an operating parameter is determined, it is assumed in the context of the invention that the core drilling device has hit a rebar, a reinforcement or a water pipe.

In an exemplary embodiment of the invention, an automatic drilling feed motor is set up to determine a feed rate. This can be done for example by way of a distance measurement with the aid of a sensor. The result of the distance measurement may preferably be used to determine the feed rate. Typical distances that occur or are measured in the context of the present invention are for example in the range from 1 to 50 mm, preferably between 1 to 25 mm and most preferably between 1 and 10 mm. These are preferably the distances until a ferrous object, such as a rebar, a reinforcing rod or a water pipe, is recognized. If the feed rate of the automatic feed device decreases rapidly in a short time, it can be assumed that a reinforcement hit has occurred. In this case, as a further method step, the automatic feed device may stop its feed, preferably instantaneously, in order to prevent further or complete severing of the object associated with the reinforcement hit.

In other words, the drilling system method disclosed here may include the following additional method step:
stopping a motor of the core drilling device and/or the automatic feed device in order to prevent complete severing of an object associated with the reinforcement hit.

It is particularly preferred in the sense of the invention that the drilling feed is stopped. It may also be preferred in the sense of the invention that the automatic drilling feed motor causes the drilling system or the core drilling device to be retracted. In this case, the drilling system or the core drilling device is in particular moved away or moved on from the location of the reinforcement hit.

It may be preferred in the sense of the invention that the feed motor of the automatic feed device is preferably stopped automatically and/or immediately. However, it may similarly be preferred in the sense of the invention that the core drilling device or its motor is preferably stopped automatically and/or immediately. In addition, both the core drilling device and the feed device may be stopped in order to prevent the object that has caused the reinforcement hit, such as a rebar, a steel girder, a reinforcing rod or a water pipe, from being completely severed. It is particularly preferred in the sense of the invention that the automatic drilling feed may stop its feed when a reinforcement hit is recognized.

After recognizing the reinforcement hit and possibly after the preferably automatic stop of the motors of the core drilling device and/or the feed device, the user may decide whether the drilling operation is continued or whether it is terminated and continued elsewhere. This can be done for example in dependence on the advice of a structural engineer, a building physicist or an architect.

It is preferred in the sense of the invention that the reliability for the recognition of a reinforcement hit is increased by using more than one recording means.

In a further exemplary embodiment, a drilling system which comprises a core drilling device and an automatic feed device is disclosed, the drilling system being set up to carry out the method according to one of the preceding claims. For this purpose, the core drilling device and/or the automatic feed device of the drilling system may comprise a recording means for recording at least one operating parameter of the core drilling device and/or the automatic feed device. This means in the sense of the invention that either the core drilling device or the feed device or both components of the drilling system may have a recording means. The terms, definitions and technical advantages introduced for the method for recognizing reinforcement hits preferably apply analogously to the drilling system. With the drilling system, a technical solution which ensures that a reinforcement hit is recognized quickly and reliably and its negative consequences are prevented by automatically switching off the core drilling device and/or the feed device can be advantageously provided.

It is preferred in the sense of the invention that the core drilling device and/or the automatic feed device comprise a display device for displaying a reinforcement hit.

It is preferred in the sense of the invention that the recognition of a reinforcement hit is passed on to the core drilling device by the automatic feed device. It is particularly preferred in the sense of the invention that there is a communication link between the core drilling device and the feed device of the drilling system, with the aid of which the information about a reinforcement hit that has occurred can be forwarded from the feed device or its drilling feed motor to the core drilling device. In the sense of the invention, it is particularly preferred that both the core drilling device and the feed device have a control device, the communication link preferably being between the control devices of the core drilling device and the feed device. It is preferred in the sense of the invention that the method steps such as “evaluation” and “assignment” take place in the control devices of the core drilling device and the feed device of the drilling system.

A combination with other parameters of the core drilling device can further increase the confidence level of recognizing a reinforcement hit. Tests have shown that in this case the drilling system reacts more reliably and stably to the recognition of the reinforcement hit.

Further advantages will become apparent from the following description of the figures. The FIGURE, the description and the claims contain numerous features in combination. A person skilled in the art will expediently also consider the features individually and combine them to form useful further combinations.

### BRIEF DESCRIPTION OF THE DRAWINGS

In the FIGURE, the same and similar components are numbered with the same reference signs. In the FIGURE:

FIG. 1 shows a view of a preferred configuration of the invention

### DETAILED DESCRIPTION

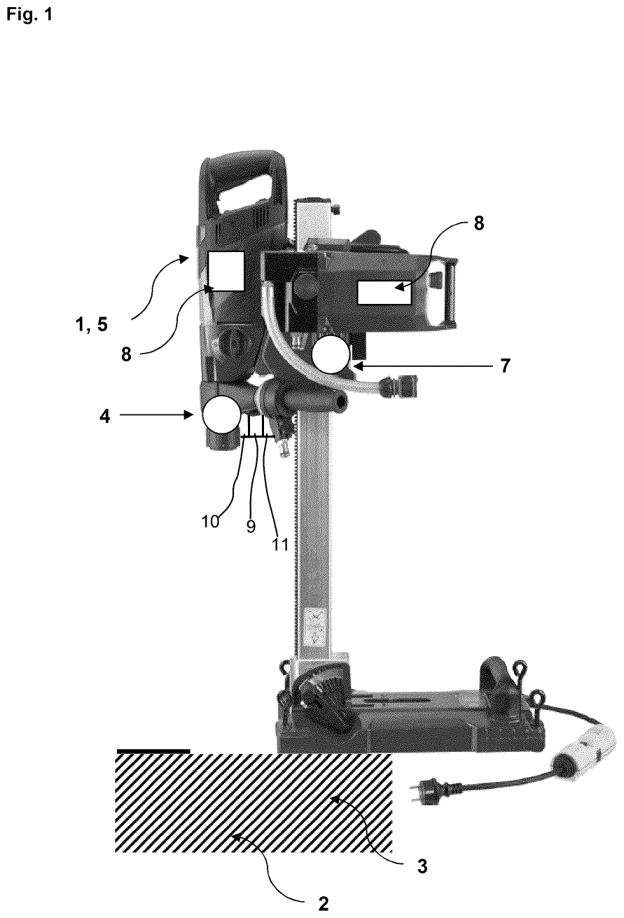

FIG. 1 shows a preferred embodiment of the power tool 1. In particular, FIG. 1 shows a power tool 1 which, in the exemplary embodiment of FIG. 1, is formed by a core drilling device. The power tool 1 may also be formed by a saw. The power tool 1 shown in FIG. 1 may form a drilling system together with an automatic feed device (without reference sign). At least one recording means 4, which is set up to record operating parameters of the power tool 1, may be present on the power tool 1. The power tool 1 is designed to analyze a composition of the substrate 2 to be processed, the power tool 1 comprising at least one recording means 4 for recording an operating parameter of the power tool 1. The analysis of the composition of the substrate 2 takes place on the basis of the at least one recorded operating parameter, the analysis being carried out within the power tool 1 itself and during the operation of the power tool 1. For this purpose, the power tool 1 may comprise control electronics and/or an evaluation unit (shown solely schematically as 10), and storage 9 and transmitter 11 for the operating parameter discussed above (shown solely schematically).

The power tool 1 may also comprise more than one recording means 4. These further recording means are identified in FIG. 1 by the reference sign 7. The recording means 4, 7 shown in FIG. 1 are schematic representations that indicate possible positions of the recording means 4, 7 on the power tool 1. However, many other positions for the recording means 4, 7 are also conceivable. The recorded operating parameters may be evaluated, preferably with the aim of identifying a reinforcement hit 3, for example if an operating parameter changes rapidly. In the context of the invention, continuous recording of the operating parameters is preferred in particular.

The power tool 1 can be used to process a substrate 2. The analysis of the composition of this substrate 2 is the subject of the proposed method. The processing of the substrate 2 may preferably take place by an essentially cylindrical drill core being cut out of the substrate 2 in order for example to lay a cable duct therein. A reinforcement hit 3 occurs when the tool of the power tool 1 hits a rebar, a reinforcing rod, a ferrous water pipe or the like during the processing operation. If the power tool 1 is designed as a core drilling device, the drill bit may for example hit the rebar or the reinforcing rod. If the power tool 1 is designed as a wall or concrete saw, for example the saw blade as the tool of the power tool 1 may hit the rebar or the reinforcing rod. Such a reinforcement hit 3 may be recognized particularly quickly and reliably by an exemplary embodiment of the invention through the recording and evaluation of operating parameters of the power tool 1, in that a rapid change in an operating parameter is viewed as a reinforcement hit 3. In other words, it may be established in the context of the present invention that there is a rapid rise or fall in an operating parameter of the power tool 1, such a rapid rise or fall in an operating parameter being associated with a reinforcement hit 3 in the context of the invention.

The operating parameters that are recorded and evaluated in the context of the invention may be distances, speeds, rotational speeds, current and voltage values, forces and torques, vibration values and the like. Accordingly, the recording means 4, 7 may be distance or length meters, speed meters, tachometers, current or voltage measuring devices, torque measuring devices or vibration measuring devices, without being restricted thereto.

It may however also be preferred in the sense of the invention that the power tool 1 comprises a control and evaluation unit in which the evaluation of the operating parameters recorded by the recording means 4, 7 can take place. It may be preferred in the sense of the invention that, in the evaluation for the recognition of the reinforcement hits 3, access is also made to data that are available to the control and evaluation unit from a different context. It represents a particular synergistic advantage of the invention that already existing data relating to the operating parameters of the power tool 1 can be taken into account in the evaluation and recognition of reinforcement hits 3 and can be evaluated with one another.

If a reinforcement hit 3 is recognized, it is preferred in the sense of the invention that the drilling operation of the power tool 1 can be stopped immediately. The preferred instantaneous stopping of the motor 5 of the power tool 1 gives the user of the core drilling device 1 time to decide how to deal with the reinforcement hit 3. It may be preferred for example that the drilling operation is interrupted at the location of the reinforcement hit 3 and continued at another location. However, it may also be preferred that the drilling operation is continued despite the reinforcement hit 3.

It may preferably be displayed on a display device 8 that a reinforcement hit 3 has been detected. The display devices 8 may for example be arranged on the power tool 1. In FIG. 1, possible positions for the display device 8 on the power tool 1 are shown. However, many other positions for the display device 8 are also conceivable.

### LIST OF REFERENCE SIGNS

1 Power tool
2 Substrate
3 Reinforcement hit
4 Recording means
5 Motor of the power tool
7 Further recording means
8 Display device
9 Storage
10 Control electronics and/or an evaluation unit
11 Communication means

1-13. (canceled)

14. A power tool for processing a substrate and designed for analyzing a composition of the substrate, the power tool comprising:
at least one recorder for recording an operating parameter of the power tool, an analysis of the composition of the substrate taking place on the basis of the at least one recorded operating parameter, the analysis being performed in the power tool itself and during operation of the power tool.

15. The power tool as recited in claim 14 further comprising storage means for storing the at least one operating parameter and results of the analysis.

16. The power tool as recited in claim 14 further comprising a display for displaying the at least one operating parameter and the results of the analysis.

17. The power tool as recited in claim 14 further comprising control electronics for evaluating or storing the at least one operating parameter and the results of the analysis.

18. The power tool as recited in claim 14 further comprising a transmitter for transmitting the at least one operating parameter and results of the analysis.

19. A method for analyzing a composition of a substrate being processed by the power tool as recited in claim 14, the method comprising:
a) providing the power tool;
b) operating the power tool and processing of a substrate;
c) recording the at least one operating parameter of the power tool with the recorder; and
d) analysis of the composition of the substrate on the basis of the at least one recorded operating parameter, the analysis being performed in the power tool itself and during operation of the power tool.

20. The method as recited in claim 19 wherein the recorded operating parameters are summarized in a work log.

21. The method as recited in claim 20 wherein the work log can be stored in control electronics of the power tool or in an external device.

22. The method as recited in claim 20 wherein the analysis includes a decision tree model.

23. The method as recited in claim 20 wherein includes an examination of features of the at least one recorded operating parameter, with properties of the at least one recorded operating parameter being examined.

24. The method as recited in claim 20 wherein the properties are statistical properties.

25. The method as recited in claim 20 wherein the analysis includes a sliding window analysis.

26. The method as recited in claim 20 wherein the analysis includes a cumulative sum analysis.

27. The method as recited in claim 20 wherein an accuracy of the analysis is improved by training the power too, the training including a comparison between composition data that are determined by the methods and composition data of materials with a known composition.
